(19) United States
(12) Patent Application Publication
(10) Pub. No.: US 2024/0223266 A1
(43) Pub. Date: Jul. 4, 2024

(54) COMMUNICATION RELAY BETWEEN NON-TERRESTRIAL DEVICES AND TERRESTRIAL DEVICES

(71) Applicant: AIRGAIN, Inc., San Diego, CA (US)

(72) Inventors: Ali Sadri, San Diego, CA (US); Cheng-Yuan Chin, San Diego, CA (US)

(21) Appl. No.: 18/543,536

(22) Filed: Dec. 18, 2023

Related U.S. Application Data
(60) Provisional application No. 63/436,973, filed on Jan. 4, 2023.

(51) Int. Cl. H04B 7/185; H04B 7/06; H04L 27/26

(52) U.S. Cl. CPC H04B 7/18513; H04B 7/0617; H04L 27/2601

(57) ABSTRACT

Systems, devices, and methods are described herein to provide communications between non-terrestrial devices and terrestrial devices. Signals received by illustrative relay devices may be demodulated from a carrier frequency and modulated onto a different carrier frequency prior to transmission or relay thereof. Further, signals received by illustrative relay devices may be decoded according to a data communication protocol, and then re-coded according to a different data protocol prior to transmission or relay thereof.

This application claims the benefit of U.S. Provisional Application No. 63/436,973 filed Jan. 4, 2023, and entitled “Communication Relay Between Non-Terrestrial Devices and Terrestrial Devices,” which is incorporated by reference in its entirety.

The disclosure herein relates to systems, devices, and methods of use in wireless communication relay between non-terrestrial devices and terrestrial devices.

The effective wireless communication range between non-terrestrial devices and terrestrial devices is often limited by uplink transmission power of the terrestrial devices. A non-terrestrial device may be any non-ground-based wireless communication device, apparatus, or platform such as, for example, a high-altitude platform station (HAPS) or atmospheric satellite, low-earth orbit satellite, medium-earth orbit satellite, a high-earth orbit or geostationary satellite, aircraft, unmanned aerial vehicle (UAV), etc. A terrestrial device may be any ground-based wireless communication device such as, e.g., cellular telephones, satellite telephones, tablet computers, personal computers, customer premises equipment (CPE), fixed wireless access (FWA), WiFi device, internet of things (IoT) device, etc.

The use, or deployment, of a repeater, for instance, to repeat a wireless signal from a terrestrial device, can improve or broaden the communication coverage with a higher uplink power. In other words, repeaters may provide extension of the wireless communication ranges between terrestrial devices and non-terrestrial devices. Additionally, the use of repeaters may improve blind spot problems.

Repeaters may be described as being capable of receiving wireless communication signals from terrestrial devices and non-terrestrial devices and then repeating the same communication signal such that it can be received by other terrestrial devices and non-terrestrial devices. The repeaters may be described as being “dumb” devices because such repeaters do not demodulate and/or decode the received communication signals, and instead, merely “repeat” the same signal. In essence, the repeaters do not perform any processing or computation on the received signals beyond re-broadcasting the same signal in an effort to extend the communication range of the received signals.

The illustrative systems, devices, and methods described herein incorporate, or provide, various functionality to improve communication relay between non-terrestrial devices and terrestrial devices over previous systems, devices, and methods as will be described.

### SUMMARY

Illustrative systems, devices, and methods may be described as providing functionality that may change the carrier frequency of received wireless signals, may change the communication protocol of received wireless signals, may move some or all of the radio unit functionality from the non-terrestrial devices to a relay device, and may provide one- or multi-hop communication legs. In one example, using the technology described herein, e.g., with no decoding or partially decoding and one-hop or multi-hop deployments, the coverage area of non-terrestrial device communications may be substantially increased and may substantially overcome different terrain constraints. Additionally, the ability of the illustrative systems, devices, and methods to offer numerous combinations of communication protocols, or waveforms, and carrier frequencies may reduce interference to existing service and enhance communication reliability. Furthermore, the movement of some or all of the radio unit (RU) functionality, which may be referred to as an intermediate radio unit (iRU), to a relay device may provide faster response times to the terrestrial devices and may reduce the hardware complexity and power consumption of the non-terrestrial devices. Still further, the use of the illustrative systems, devices, and methods may make wireless communication links between non-terrestrial devices and relay devices more efficient with various combinations standard and propriety communication protocols. In one example, the illustrative systems, devices, and methods may use of a 3GPP-compliant service data unit (SDU) or protocol data unit (PDU) (e.g., including header, padding and payload) and proprietary physical layer (PHY).

One illustrative relay device may provide communication between a non-terrestrial device and a terrestrial device. The delay device may include a wireless communication apparatus comprising one or more antennas to wirelessly communicate with a non-terrestrial device and a terrestrial device and computing apparatus comprising one or more processors. The computing apparatus may be configured to receive and demodulate a first signal on a first carrier frequency from the terrestrial device resulting in a data signal, modulate the data signal on a second carrier frequency generating a second signal, and transmit the second signal to the non-terrestrial device.

One illustrative method may include wirelessly receiving and demodulate a first signal on a first carrier frequency from a terrestrial device resulting in a data signal, modulating the data signal on a second carrier frequency generating a second signal, and wirelessly transmitting the second signal to a non-terrestrial device.

One illustrative system may include a non-terrestrial device and a relay device to provide wireless communication between the non-terrestrial device and a terrestrial device. The relay device may be configured to receive and demodulate a first signal on a first carrier frequency from the terrestrial device resulting in a data signal, modulate the data signal on a second carrier frequency generating a second signal, and transmit the second signal to the non-terrestrial device.

The above summary is not intended to describe each embodiment or every implementation of the present disclosure. A more complete understanding will become apparent and appreciated by referring to the following detailed description and claims taken in conjunction with the accompanying drawings.

### BRIEF DESCRIPTION OF THE DRAWINGS

FIG. 1 is diagram of a communication system including terrestrial devices and non-terrestrial devices.

FIG. 2 is diagram of an illustrative communication system including terrestrial devices, non-terrestrial devices, and relay devices.

FIG. 3 is diagram of another illustrative communication system including terrestrial devices, non-terrestrial devices, and relay devices.

FIG. 4 is a functional diagram of a non-terrestrial device, a repeater device, and a terrestrial device.

FIG. 5 is a functional diagram of a non-terrestrial device, an illustrative relay device, and a terrestrial device.

FIG. 6 is a block diagram of an illustrative relay device.

FIG. 7A is an illustration of coverage area of a conventional non-terrestrial device.

FIG. 7B is an illustration of coverage area of a non-terrestrial device when utilizing an illustrative relay device.

FIG. 8 is a graph of connection probability versus received power when utilizing and without utilizing an illustrative relay device.

### DETAILED DESCRIPTION OF ILLUSTRATIVE EMBODIMENTS

In the following detailed description of illustrative embodiments, reference is made to the accompanying figures of the drawing which form a part hereof, and in which are shown, by way of illustration, specific embodiments which may be practiced. It is to be understood that other embodiments may be utilized, and structural changes may be made without departing from (e.g., still falling within) the scope of the disclosure presented hereby.

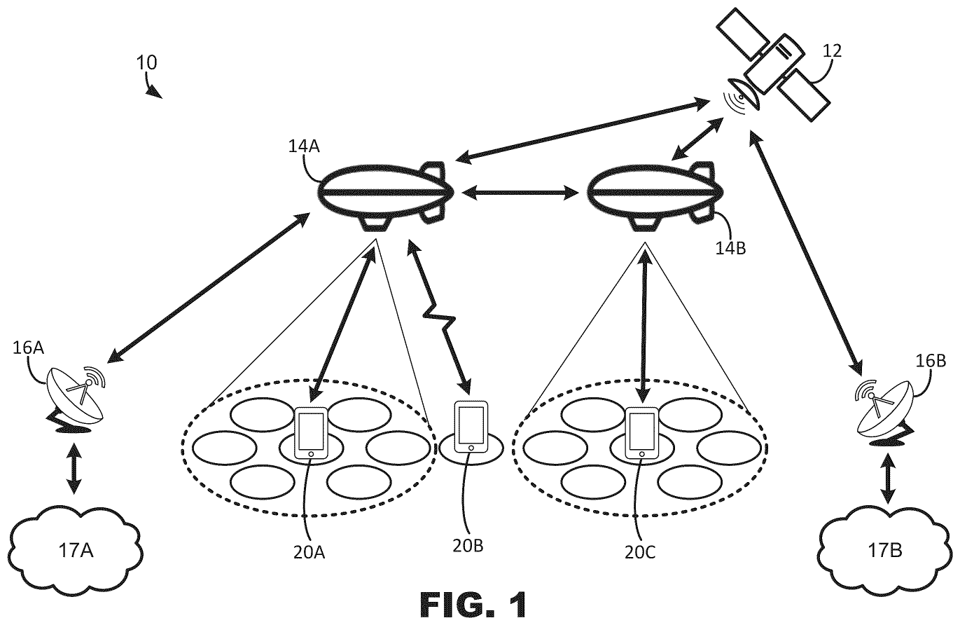

Illustrative systems, devices, and methods shall be described with reference to FIGS. 1-8. It will be apparent to one skilled in the art that elements or processes from one embodiment may be used in combination with elements or processes of the other embodiments, and that the possible embodiments of such systems, devices, and methods using combinations of features set forth herein is not limited to the specific embodiments shown in the figures and/or described herein. Further, it will be recognized that the embodiments described herein may include many elements that are not necessarily shown to scale. Still further, it will be recognized that timing of the processes and the size and shape of various elements herein may be modified but still fall within the scope of the present disclosure, although certain timings or types of elements may be advantageous over others.

An illustrative system 10 including multiple non-terrestrial devices and terrestrial devices is depicted in FIG. 1. The non-terrestrial devices include a space satellite 12 (e.g., a low-earth orbit, low-earth orbit satellite, medium-earth orbit satellite, and high-earth orbit satellite) and two atmospheric satellites 14A, 14B. The atmospheric satellites 14A, 14B may also be referred to as or high-altitude platform stations (HAPS). The space satellites 12 may operate in altitudes about 1200 miles from the earth's surface while the atmospheric satellites 14A, 14B may operate in altitudes between about 3 miles and about 30 miles from the earth's surface. In one or more embodiments, the atmospheric satellites 14A, 14B may operate in the troposphere, which is approximately 5 miles to 11 miles above the earth's surface. In this example, the atmospheric satellites 14A, 14B are balloons or blimps that may be filled with one or more gases to maintain aloft. In other examples, the atmospheric satellites 14A, 14B may include wings, rotors, and/or any other device or apparatus to maintain aloft.

The space satellite 12 and the atmospheric satellites 14A, 14B may be configured to provide wireless communications between each other and various terrestrial devices. In particular, the space satellite 12 and the atmospheric satellites 14A, 14B may include computing and communication circuitry and apparatus such as, e.g., one or more processors or processing circuitry, power systems, antenna apparatus, amplifiers, etc. to provide such wireless communications. As shown, each of the non-terrestrial devices is communicatively coupled to each other via wireless communication as illustrated using bidirectional lines. In particular, the atmospheric satellite 14A is wirelessly communicatively coupled to each of the atmospheric satellite 14A and the space satellite 12, the atmospheric satellite 14B is wirelessly communicatively coupled to each of the atmospheric satellite 14B and the space satellite 12, and the space satellite 12 is wirelessly communicatively coupled to each of the atmospheric satellites 14A, 14B. The communicative, or operable, coupling of the non-terrestrial devices provides bidirectional communication between each of the non-terrestrial devices. Additionally, although in this embodiment, each of the non-terrestrial devices is directly communicatively coupled to each other, in other embodiments, non-terrestrial devices may be indirectly coupled to each other through other non-terrestrial devices. In other words, communications between non-terrestrial devices that are not directly communicatively coupled may be relayed or repeated though another non-terrestrial device.

The terrestrial devices may include ground stations 16A, 16B, each of which are communicatively coupled (e.g., through wired or wireless connections) to core networks 17A, 17B as represented by the bidirectional lines extending therebetween. In turn, the core networks 17A, 17B may be communicatively coupled to one or more other networks such as, for instance, the Internet. The terrestrial devices may further include user devices 20A, 20B, 20C (which may also be referred to as user equipment). The ground stations 16A, 16B may be communicatively coupled to the non-terrestrial devices via wireless communication as illustrated using bidirectional lines. As shown, the ground station 16A is wirelessly communicatively coupled to the atmospheric satellite 14A, and the ground station 16B is wirelessly communicatively coupled to the space satellite 12.

Generally, the user devices 20A, 20B, 20C may have less communication range than other devices of the system 10. For example, the range of each user device 20A, 20B, 20C may be represented by the solid-line circle within which each of the user devices 20A, 20B, 20C is positioned in FIG. 1. The non-terrestrial devices such as the atmospheric satellites 14A, 14B may have more communication range than the user devices 20A, 20B, 20C, which is represented by the larger dashed-line circle conically projected therefrom.

Terrestrial devices may lack the communication range to effectively communicate with non-terrestrial devices depending on, e.g., the location and position the terrestrial devices and the non-terrestrial devices, the power provided by the terrestrial devices and non-terrestrial devices, etc. For example, as shown, the user device 20B is not within the communication range of either of the atmospheric satellite 14A, 14B, and thus, is not wirelessly communicatively coupled to either of the atmospheric satellite 14A, 14B as represented by the broken double ended arrow extending between the user device 20B and the atmospheric satellite 14A. As a result, some terrestrial device such as user device 20B may not have wireless communication coverage using the system 10.

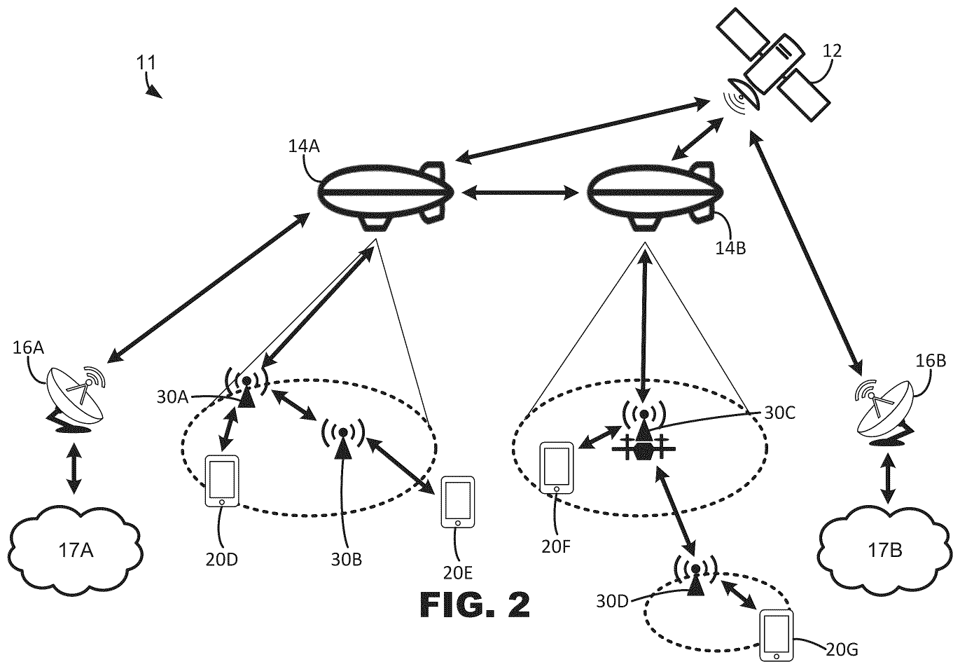

Another communication system 11 including terrestrial devices and non-terrestrial devices is depicted in FIG. 2. The terrestrial devices and non-terrestrial devices of FIG. 2 may be substantially similar to those described herein with reference to FIG. 1. For example, the system 11 of FIG. 2 includes the same space satellite 12, atmospheric satellites 14A, 14B, ground stations 16A, 16B, and core networks 17A, 17B as shown and substantively arranged as shown in FIG. 1.

The system 11, however, also includes relay devices 30A, 30B, 30C, 30D to, for example, to expand the coverage of the atmospheric satellites 14A, 14B. Generally, the relay devices 30A, 30B, 30C, 30D are configured to provide wireless communication between one or more non-terrestrial devices, one or more terrestrial devices, and one or more other relay devices. In particular, the relay devices 30A, 30B, 30C may be described as being able to bridge communications, or communicative couplings, between the user devices 20D, 20E, 20F, 20G, the atmospheric satellites 14A, 14B, and the other relay devices. Each relay device 30A, 30B, 30C, 30D may include, among other things, wireless communication apparatus to wirelessly communicate with non-terrestrial devices and terrestrial devices. The wireless communication apparatus may include, among other things, one or more antennas. The one or more antennas may be specifically configured to receive and transmit communications utilizing one or more (e.g., one of or a plurality of) carrier frequencies and/or frequency ranges. Each relay device 30A, 30B, 30C, 30D may further include computing apparatus comprising one or more processors configured to provide the relayed communication between the non-terrestrial devices, terrestrial devices, and other relay devices.

For example, the relay device 30A may provide relayed communication signals between the user device 20D and the atmospheric satellite 14A. In particular, the relay device 30A may receive communication signals from the user device 20D and retransmit, or relay, such communication signals to the atmospheric satellite 14A, and conversely, receive communication signals from the atmospheric satellite 14A and retransmit, or relay, such communication signals to the user device 20D. Further, for example, the relay device 30B may provide relayed communication signals between the user device 20E and the relay device 30A. In particular, the relay device 30B may receive communication signals from the user device 20E and retransmit, or relay, such communication signals to the relay device 30A, and conversely, receive communication signals from the relay device 30A and retransmit, or relay, such communication signals to the user device 20E.

As shown, the user device 20E is outside the communication range of the atmospheric satellites 14A, 14B, which are represented by the dashed circles conically projected therefrom. As result, the user device 20E, similar to the user device 20B of FIG. 1, would not be able to directly communicate, or be communicatively coupled to or with, the atmospheric satellites 14A, 14B. However, the relayed devices of the system 11, and in particular, the relay devices 30A, 30B provide extended coverage such that the user device 20E may communicate, or be communicatively coupled, to an atmospheric satellite, and in this example, atmospheric satellite 14A.

The relay devices may be airborne or ground based. Additionally, the relay devices may be moveable (e.g., moveable along the ground surface, movable in three dimensions such as in the air, etc.) or fixed (e.g., positioned in a fixed location, unmovable, stationary, etc.). In this example, the relay devices 30A, 30B, and 30D are ground-based while the relay device 30C is airborne. As shown, the representation of the relay device 30C further depicts a quad-copter drone to indicate that the relay device 30C is an airborne device. It is to be understood that a quad-copter drone is merely only example of an airborne relay device, and any low altitude flying device and apparatus may utilized to provide airborne capabilities to a relay device.

As shown, the relay device 30C may provide relayed communication signals between the user device 20F and the atmospheric satellite 14B and between the relay device 30D and the atmospheric satellite 14B. In particular, the relay device 30C may receive communication signals from the user device 20F and the relay device 30D and retransmit, or relay, such communication signals to the atmospheric satellite 14B, and conversely, receive communication signals from the atmospheric satellite 14B and retransmit, or relay, such communication signals to the user device 20F and the relay device 30D. Additionally, the relay device 30D may provide relayed communication signals between the user device 20G and the relay device 30C. In particular, the relay device 30D may receive communication signals from the user device 20G and retransmit, or relay, such communication signals to the relay device 30C, and conversely, receive communication signals from the relay device 30C and retransmit, or relay, such communication signals to the user device 20G.

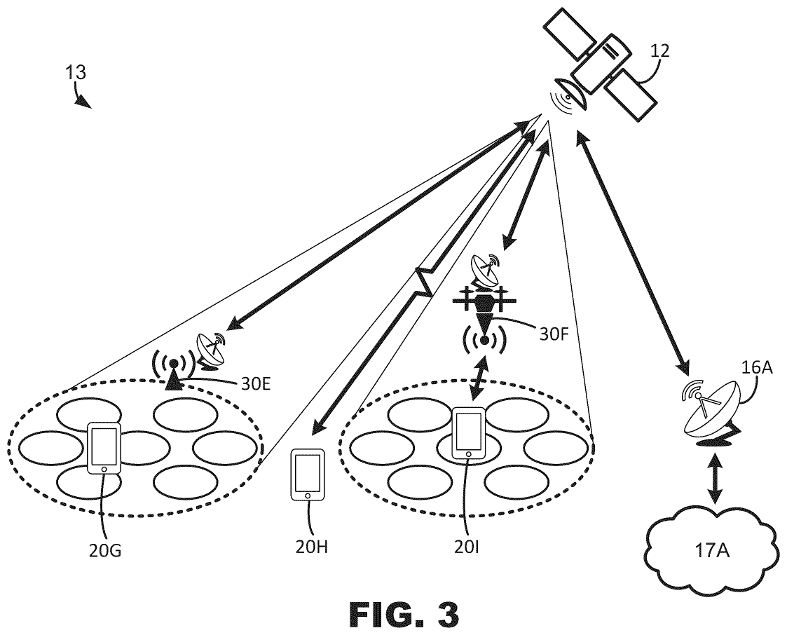

Another communication system 13 including terrestrial devices and non-terrestrial devices is depicted in FIG. 3. Many of the terrestrial devices and non-terrestrial devices may be substantially similar to those described herein with reference to FIGS. 1-2. For example, the system 13 of FIG. 3 includes the same space satellite 12, ground station 16A, and core network 17A as shown and substantively arranged as shown in FIGS. 1-2. The system 13, however, does not include atmospheric satellites, and in turn, includes relay devices 30E, 30F that are configured to provide relayed wireless communication signals between user devices and the space satellite 12. In this example, a user device 20H is outside the coverage range and/or does not have enough power to communicate, or be communicatively coupled, to either of the space satellite 12 (as shown by the broken double ended arrow extending between the user device 20H and the space satellite 12) or the relay devices 30E, 30F.

Also, as shown, the relay device 30E may provide relayed communication signals between the user device 20G and the space satellite 12. In particular, the relay device 30E may receive communication signals from the user device 20G and retransmit, or relay, such communication signals to the space satellite 12, and conversely, receive communication signals from the space satellite 12 and retransmit, or relay, such communication signals to the user device 20G. Further, the relay device 30F, which is an airborne relay device as depicted with a quadcopter drone, may provide relayed communication signals between the user device 20I and the space satellite 12. In particular, the relay device 30F may receive communication signals from the user device 20I and retransmit, or relay, such communication signals to the space satellite 12, and conversely, receive communication signals from the space satellite 12 and retransmit, or relay, such communication signals to the user device 20I.

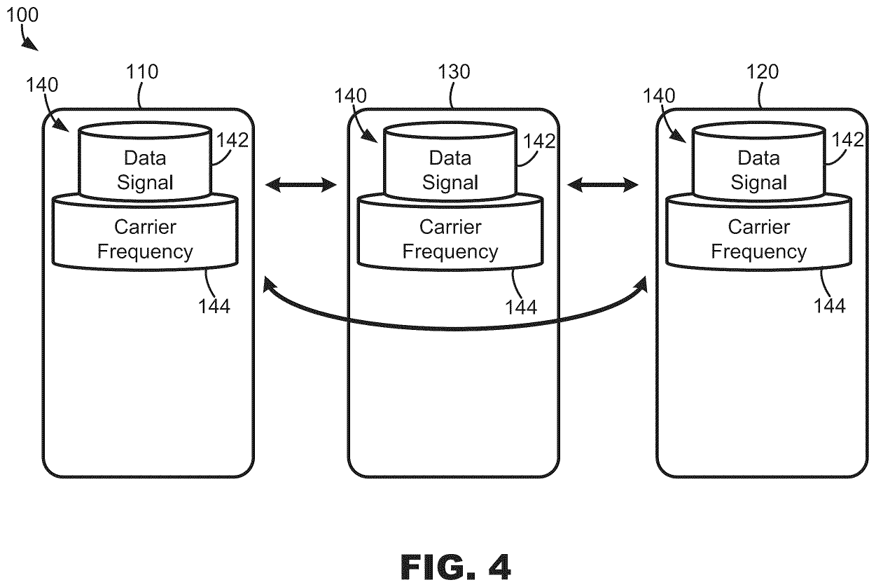

A functional diagram of system 100 including a non-terrestrial device 110, a relay device 130, and a terrestrial device 120 is depicted in FIG. 4. As shown, each of the non-terrestrial device 110, the relay device, and the terrestrial device 120 are capable of transmitting and receiving a communication signal 140 between each other as represented by the double-ended arrows using various computing apparatus and wireless communication apparatus. The communication signal 140 may be defined by at least a carrier frequency 144 and data signal 142 on the carrier frequency 144. The carrier frequency 144 may be any frequency known by those skilled in the art to provide communications between the non-terrestrial device 110, the relay device 130, and the terrestrial device 120. In one or more examples, the carrier frequency 144 may be a cellular frequency such as any of one of one of LTE as defined in 3GPP, 5G as defined in 3GPP, 6G as defined in 3GPP, etc., a satellite communication frequency such as any of one of one of L, S, C, X, Ku, K, Ka, etc., any WiFi communication frequency as defined by the WiFi Alliance, and any other frequency for IoT devices.

The data signal 142 may be in accordance with, or follow, any communication protocol known by those skilled in the art to provide communications between the non-terrestrial device 110, the relay device 130, and the terrestrial device 120. In one or more examples, the data signal 142 may be encoded according to a cellular data protocol such as any of one of one of LTE as defined in 3GPP, 5G as defined in 3GPP, 6G as defined in 3GPP, any 3GPP-compliant payload, any SatCom-compliant payload, any WiFi-compliant payload, any IoT-compliant payload, etc.

In system 100, the carrier frequency 144 and data signal 142 utilized by the user device 120 and the non-terrestrial device 110 is the same, and the relay device 130 may merely repeat or relay the communication signal received from the user device 140 or non-terrestrial device 110 without changing or modifying the carrier frequency 144 or the data signal 142. In this way, the relay device 130 may be described as merely repeating or relaying the communication signals 140 it receives without demodulating or decoding the communication signals.

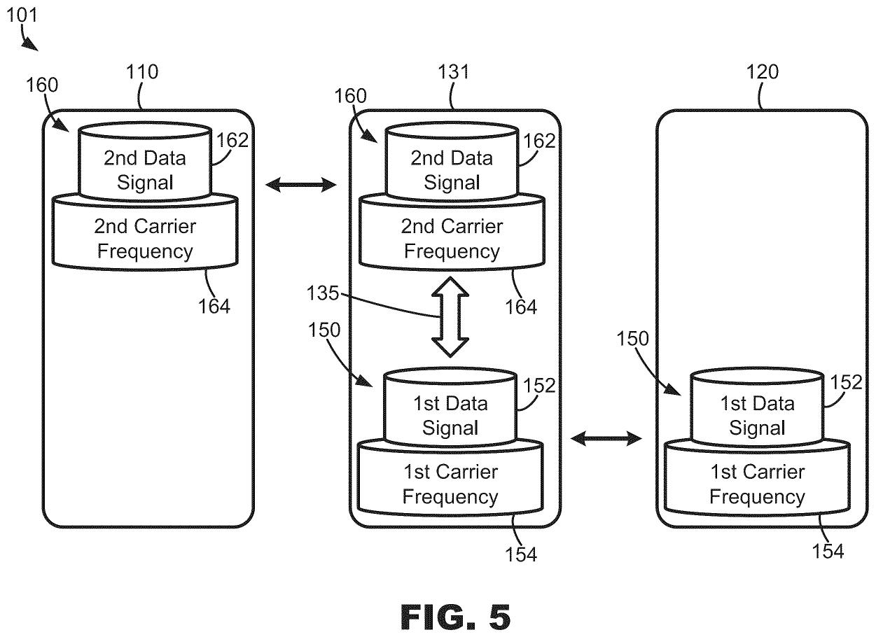

In contrast to the system 100 of FIG. 4, a functional diagram of an illustrative system 101 including the non-terrestrial device 110, a relay device 131, and the terrestrial device 120 is depicted in FIG. 5. In this embodiment, the relay device 131 includes apparatus and functionality associated therewith configured to change the carrier frequency of a received signal before relaying the signal and/or to change the communication protocol of the data signal that is on the carrier frequency. In this way, different carrier frequencies and/or communication protocols can be used between the non-terrestrial device 110 and the relay device 131 than are used between the terrestrial device 120 and the relay device 131. In other words, only one or both of carrier frequency and communication protocol may be changed, or modified, by the relay device 131 prior to relay, or re-transmission, of the communication signal.

For example, as shown in the system 101 of FIG. 5, a communication signal 150 transmitted by the user device 120 may include, or define, a first data signal 152 according to a first data protocol (e.g., encoded in accordance with a first data protocol) modulated, or carried, on a first carrier frequency 154. The carrier frequency 154 may be any frequency known by those skilled in the art to provide communications between the relay device 131 and the terrestrial device 120. In one or more examples, the carrier frequency 154 may be a cellular frequency such as any of one of one of LTE as defined in 3GPP, 5G as defined in 3GPP, 6G as defined in 3GPP, etc., a satellite communication frequency such as any of one of one of L, S, C, X, Ku, K, Ka, etc., any WiFi communication frequency as defined by the WiFi Alliance, and any other frequency for IoT devices.

The first data signal 152 may be in accordance with, or follow, any communication protocol known by those skilled in the art to provide communications between the relay device 131 and the terrestrial device 120. In one or more examples, the data signal 152 may be encoded according to a cellular data protocol such as any of one of one of LTE as defined in 3GPP, 5G as defined in 3GPP, 6G as defined in 3GPP, any 3GPP-compliant payload, any SatCom-compliant payload, any WiFi-compliant payload, any IoT-compliant payload, etc.

Upon reception of the first communication signal 150, the relay device 131 may then perform, or execute, one or more processes 135 on the first communication signal 150 resulting in a second communication signal 160. The second communication signal 160 may include, or define, a second data signal 162 according to a second data protocol (e.g., encoded in accordance with a second data protocol) modulated, or carried, on a second carrier frequency 164. The relay device 131 may be configured to modify one or both of the data signal and carrier frequency from the first communication signal 150 thereby providing the second communication signal 160.

For example, the relay device 131 may change both the data signal and carrier frequency of the received communication signal before transmitting, or relaying, it to the non-terrestrial device 110. More specifically, the relay device 131 may demodulate the first communication signal 150 from the first carrier frequency 154 resulting in the first data signal 152, and then decode the first data signal 152 according to a first communication protocol into a data block. The data block may be encoded according to a second communication protocol that is different from the first communication protocol resulting in the second data signal 162, and then modulate the second data signal 152 onto a second carrier frequency 164 that is different than the first carrier frequency 154 resulting in the second communication signal 160 that may be transmitted, or relayed, to the non-terrestrial device 110.

For example, the relay device 131 may only change the carrier frequency of the received communication signal before transmitting, or relaying, it to the non-terrestrial device 110. More specifically, the relay device 131 may demodulate the first communication signal 150 from the first carrier frequency 154 resulting in the first data signal 152, and then may modulate the first data signal 152 onto a second carrier frequency that is different than the first carrier frequency 154 resulting in the second communication signal 160 that may be transmitted, or relayed, to the non-terrestrial device 110. In this example, the second data signal 162 is an unmodified copy of the first data signal 152. Additionally, since the first data signal 152 is unmodified in this example, the relay 131 has no need to decode the first data signal 152, and instead, will simply pass the first data signal 152 along to be utilized as the second data signal 162 prior to modulation onto the second carrier frequency 164.

Further, for example, the relay device 131 may only change the data signal of the received communication signal before transmitting, or relaying, it to the non-terrestrial device 110. More specifically, the relay device 131 may demodulate the first communication signal 150 from the first carrier frequency 154 resulting in the first data signal 152, and then decode the first data signal 152 according to a first communication protocol into a data block. The data block may be encoded according to a second communication protocol that is different from the first communication protocol resulting in the second data signal 162. The second data signal 152 may then be modulated onto a second carrier frequency 164 that is the same as the first carrier frequency 154 resulting in the second communication signal 160 that may be transmitted, or relayed, to the non-terrestrial device 110.

In one or more examples, the second carrier frequency 164 may be a cellular frequency such as any of one of one of LTE as defined in 3GPP, 5G as defined in 3GPP, 6G as defined in 3GPP, etc., a satellite communication frequency such as any of one of one of L, S, C, X, Ku, K, Ka, etc., any WiFi communication frequency as defined by the WiFi Alliance, and any other frequency for IoT devices. In one or more examples, the second data signal 162 may be encoded according to a cellular data protocol such as any of one of one of LTE as defined in 3GPP, 5G as defined in 3GPP, 6G as defined in 3GPP, any 3GPP-compliant payload, any SatCom-compliant payload, any WiFi-compliant payload, any IoT-compliant payload, etc.

Also, the second data signal 162 may be utilize a non-standardized or partially non-standardized communication protocol to encode the second data signal 162. For example, the data signal 162 may be encoded using a combination of a 3GPP-compliant service data unit (SDU) and/or or protocol data unit (PDU) (e.g., including header, padding and payload) and a proprietary physical (PHY) layer. In other words, for example, a 3GPP-compliant waveform may be utilized or a proprietary waveform having a 3GPP payload may be utilized.

Additionally, the relay device 131 may also provide beam forming or shaping functionality so as to provide improved communication with the terrestrial device 120 and/or non-terrestrial device 110. More specifically, the relay device 131 may include beam forming a communication beam at the first carrier frequency to the terrestrial device 120 and/or beam forming a communication beam at the second carrier frequency to the non-terrestrial device 110.

Moreover, it is be understood that the relay device 131 is a bidirectional communication relay that not only relays communication signals from the terrestrial device 120 to the non-terrestrial device 110 but also relays communication signals from the non-terrestrial device 110 to the terrestrial device 120. Such communication signals received from the non-terrestrial device 110 may be changed, or modified, in the substantially the same was as described herein when received from the terrestrial device 120 but in the opposite direction.

Thus, in one or more embodiments, it may be described that the distributed unit (DU) and the radio unit (RU) are separated from one another using the relay device 131, and an intermediate radio unit (iRU) is introduced between them. In other words, the radio unit may be described as being separated from the non-terrestrial device 110 and merged within the relay device 131, which may be referred to as a “smart” repeater. Additionally, it is to be understood that no frequency limitation may be placed on relay device 131 (e.g., no frequency limitation may be placed on intermediate radio unit). Also, the relationship between the non-terrestrial device 110 and the relay device 131 may be defined by a RAN split such, e.g., RAN split 8 wherein the layer one functionality, e.g., RF and radio unit functionality, may be located in, or performed by, the relay device 131.

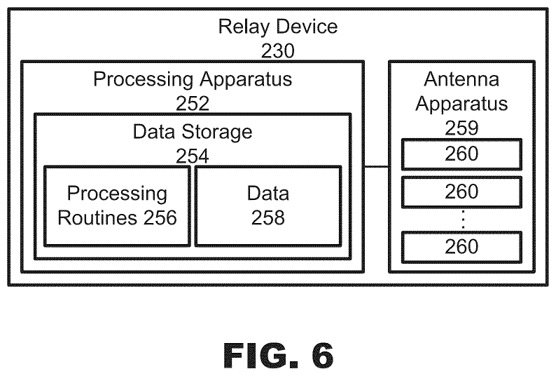

An illustrative relay device 230 is depicted in FIG. 6. The illustrative relay device 230 may include, among other things, a processing apparatus 252 and antenna apparatus 259. The processing apparatus 252 may generally include any hardware and software so as to be able to perform or execute the illustrative methods and processes described herein. The processing apparatus 252 may be communicatively coupled to the antenna apparatus 259 to receive and transmit, among other things, communication signals from non-terrestrial devices, terrestrial devices, and other relay devices as described herein. Generally, the processing apparatus 252 may be configured to perform or execute a variety of methods and processes including one or more of receiving communication signals using the antenna apparatus 259, transmitting communication signals using the antenna apparatus 259, demodulating communication signals into data signals, modulating data signals into communication signals, decoding data signals according to communication protocols into data blocks, encoding data blocks according to communication protocols into data signals, and beam forming or shaping using the antenna apparatus 259 to receive and transmit communication signals as described in more detail herein. More generally, the processing apparatus 252 may be described as providing enhanced relay functionality to provide more efficient and larger communication coverage for terrestrial devices and non-terrestrial devices.

Further, the processing apparatus 252 includes data storage 254. The data storage 254 allows for access to processing programs or routines 256 and one or more other types of data 258 that may be employed to carry out the illustrative communication and relay methods and processes described herein. For example, processing programs or routines 256 may include programs or routines for performing signal processing algorithms, signal modulation algorithms, signal demodulation algorithms, signal decoding algorithms, signal encoding algorithms, beam forming or shaping algorithms, data processing algorithms, data packet generation algorithms, data packet processing algorithms, comparison algorithms, computational mathematics, matrix mathematics, compression algorithms (e.g., data compression algorithms), vector mathematics, or any other processing required to implement one or more embodiments as described herein.

The data 258 may include, for example, communication signals received using the antenna apparatus 259, data signals demodulated from received communication signals, modulated communication or data signals, data blocks decoded from data signals, data signals encoded from the data blocks, communication signals for transmission using the antenna apparatus 259, one or more (e.g., a plurality) of communication protocols, results from one or more processing programs or routines employed according to the disclosure herein, or any other data that may be necessary for carrying out the one or more processes or methods described herein.

In one or more embodiments, the relay device 230 including the processing apparatus 252 may be implemented using one or more computer programs executed on programmable computers, such as computers that include, for example, processing capabilities (e.g., microcontrollers and/or programmable logic devices), data storage (e.g., volatile or non-volatile memory and/or storage elements), input devices, and output devices. Program code and/or logic described herein may be applied to input data to perform functionality described herein and generate desired output information. The output information may be applied as input to one or more other devices and/or processes as described herein or as would be applied in a known fashion.

The programs used to implement the processes described herein may be provided using any programmable language, for example, a high-level procedural and/or object orientated programming language that is suitable for communicating with a computer system. Any such programs may, for example, be stored on any suitable device, for example, a storage media, readable by a general or special purpose program, computer or a processor apparatus for configuring and operating the computer when the suitable device is read for performing the procedures described herein. In other words, at least in one embodiment, the relay device 230 including the processing apparatus 252 may be implemented using a computer readable storage medium, configured with a computer program, where the storage medium so configured causes the computer to operate in a specific and predefined manner to perform functions described herein. The exact configuration of the processing apparatus 252 is not limiting and essentially any device capable of providing suitable computing capabilities and control capabilities (e.g., receiving and transmitting communication signals, modulating and demodulating communication signals, encoding and decoding data signals, and/or beam forming or shaping) may be used.

Further, in one or more embodiments, the output such as, for example, communication signals may be analyzed by another machine such as non-terrestrial devices, terrestrial devices, and/or other relay devices that provides output based thereon. As described herein, a digital file may be any medium (e.g., volatile or non-volatile memory, a memory card, a magnetic storage medium such as a hard disk, a CD-ROM, a punch card, and/or magnetic recordable tape) containing digital bits (e.g., encoded in binary, and/or trinary) that may be readable and/or writeable by processing apparatus 252 described herein. Also, as described herein, a file in user-readable format may be any representation of data (e.g., ASCII text, binary numbers, hexadecimal numbers, decimal numbers, audio, and/or graphical) presentable on any medium (e.g., paper, a display, and/or sound waves) readable and/or understandable by a user.

In view of the above, it will be readily apparent that the functionality as described in one or more embodiments according to the present disclosure may be implemented in any manner as would be known to one skilled in the art. As such, the computer language, the computer system, or any other software/hardware which is to be used to implement the processes described herein shall not be limiting on the scope of the systems, processes or programs (e.g., the functionality provided by such systems, processes, and/or programs) described herein.

The methods described in this disclosure, including those attributed to the systems, asset tag device, or various constituent components, may be implemented, at least in part, in hardware, software, firmware, or any combination thereof. For example, various aspects of the techniques may be implemented within one or more processors, including one or more microprocessors, DSPs, ASICS, FPGAs, CPLDs, microcontrollers, or any other equivalent integrated or discrete logic circuitry, as well as any combinations of such components, image processing devices, or other devices. The term “processing apparatus,” “processor,” or “processing circuitry” may generally refer to any of the foregoing logic circuitry, alone or in combination with other logic circuitry, or any other equivalent circuitry.

Such hardware, software, and/or firmware may be implemented within the same device or within separate devices to support the various operations and functions described in this disclosure. In addition, any of the described components may be implemented together or separately as discrete but interoperable logic devices. Depiction of different features, for example, using block diagrams, is intended to highlight different functional aspects and does not necessarily imply that such features must be realized by separate hardware or software components. Rather, functionality may be performed by separate hardware or software components, or integrated within common or separate hardware or software components.

When implemented in software, the functionality ascribed to the systems, devices and methods described in this disclosure may be embodied as instructions on a computer-readable medium such as RAM, ROM, NVRAM, EEPROM, FLASH memory, magnetic data storage media, optical data storage media, or the like. The instructions may be executed by one or more processors to support one or more aspects of the functionality described in this disclosure.

The antenna apparatus 259 of the relay device 230 may include one or more (e.g., a plurality of, an array of, a plurality of arrays of, etc.) antennas 260 that may be configured to transmit and receive radiofrequency (RF) signals to perform the functionality and processes described herein. In particular, the antenna apparatus 259, in conjunction with the processing apparatus 252, may be configured to transmit and receive communication signals in the cellular frequencies such as any of one of one of LTE as defined in 3GPP, 5G as defined in 3GPP, 6G as defined in 3GPP, etc. and/or satellite communication frequencies such as any of one of one of L, S, C, X, Ku, K, Ka, etc., any WiFi communication frequency as defined by the WiFi Alliance, and any other frequency for IoT devices. Each of the one or more antennas 260 of the antenna apparatus 259 may be configured for a particular type of communication and frequency. For example, the antenna apparatus 259 may include one or more antennas 260 configured for cellular signals and frequencies and one or more antennas 260 configured for LTE satellite communication signals and frequencies. For example, the antenna apparatus 259 may include one or more antennas 260 configured for WiFi signals and frequencies and one or more antennas 260 configured for LTE satellite communication signals and frequencies.

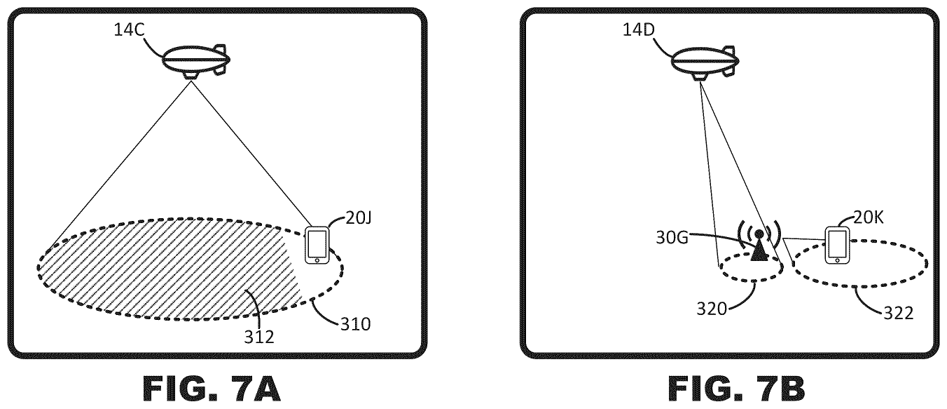

An illustration of coverage area 310 of a non-terrestrial device 14C and a terrestrial device 20J is shown in FIG. 7A. As shown, a substantial amount of energy, or power, may be considered to be wasted in providing the coverage area 310 for a single user device 20J. For instance, the cross-hatched area 312 of the coverage area 310 may be over an area of the earth where it is unlikely that any terrestrial devices would be located such as a canyon, body of water, etc., and thus, coverage of the cross-hatched area 312 may be considered to be a waste of energy.

An illustration of coverage area 320 of a non-terrestrial device 14D when utilizing an illustrative relay device 30G is depicted in FIG. 7B. As can be seen, the non-terrestrial device 14D may provide a much smaller coverage area 320 so as to be able to communicate, or communicatively couple, to the relay device 30G, which may provide the coverage area 322 such that the user device 20K may communicate, or communicatively couple, to the relay device 30G. In particular, in one example, the non-terrestrial device 14D may utilize a higher carrier frequency (e.g., Ka band, E band) and utilize a restricted-size antenna array panel.

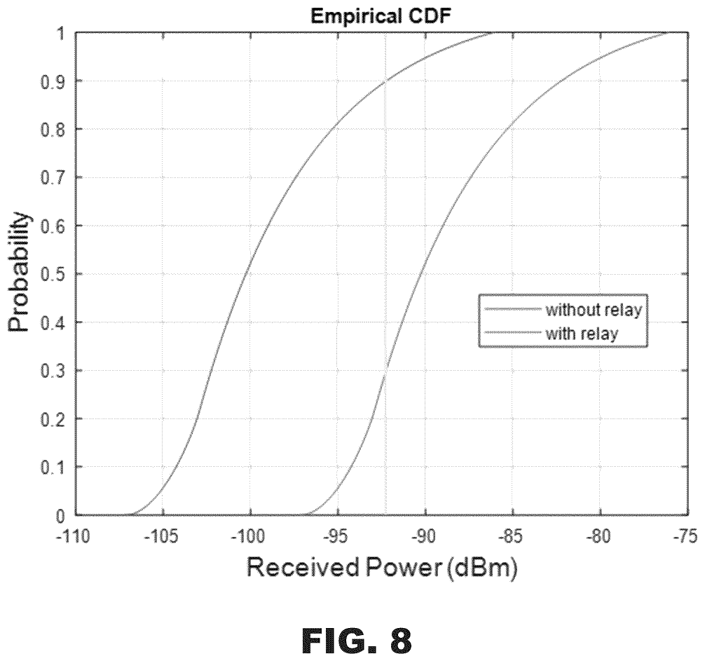

An empirical cumulative distribution function graph of connection probability versus received power when utilizing and without utilizing an illustrative relay device is shown in FIG. 8. As shown, given a received power sensitivity threshold of −92 dBm, the number of connected users increase would increase from about 10% to about 70% when utilizing an illustrative relay device as described herein.

Below there is provided a non-exhaustive listing of non-limiting examples. Any one or more of the features of these examples may be combined with any one or more features of another example, embodiment, or aspect described herein.

Example Ex1: A relay device to provide communication between a non-terrestrial device and a terrestrial device comprising:
a wireless communication apparatus comprising one or more antennas to wirelessly communicate with a non-terrestrial device and a terrestrial device; and
a computing apparatus comprising one or more processors and configured to:
   receive and demodulate a first signal on a first carrier frequency from the terrestrial device resulting in a data signal;
   modulate the data signal on a second carrier frequency generating a second signal; and
   transmit the second signal to the non-terrestrial device.

Example Ex2: A method comprising:
wirelessly receiving and demodulate a first signal on a first carrier frequency from a terrestrial device resulting in a data signal;
modulating the data signal on a second carrier frequency generating a second signal; and
wirelessly transmitting the second signal to a non-terrestrial device.

Example Ex3: The device of Example Ex1 or the method of Example Ex2, wherein receiving and demodulating the first signal on the first carrier frequency from the terrestrial device comprises beam forming a communication beam at the first carrier frequency to the terrestrial device.

Example Ex4: The device or method as in any one of Examples Ex1-Ex3, wherein the first carrier frequency is different than the second carrier frequency.

Example Ex5: The device or method as in any one of Examples Ex1-Ex3, wherein the first carrier frequency is the same as the second carrier frequency.

Example Ex6: The device or method as in any one of Examples Ex1-Ex5, wherein one or both of the first and second carrier frequencies is one of LTE, 5G, and 6G as defined in 3GPP.

Example Ex7: The device or method as in any one of Examples Ex1-Ex6, wherein the computing apparatus of the device is further configured to execute or the method further comprises, prior to the modulating the data signal:
decoding the data signal according to a first communication protocol generating a data block; and
encoding the data block according to a second communication protocol resulting in the data signal for modulation.

Example Ex8: The device or method as in Example Ex7, wherein the first communication protocol is different than the second communication protocol.

Example Ex9: The device or method as in Example Ex7, wherein the first communication protocol is the same as the second communication protocol.

Example Ex10: The device or method as in any one of Examples Ex7-Ex19, wherein one or both of the first and second communication protocols is one of LTE, 5G, and 6G as defined in 3GPP.

Example Ex11: The device or method as in any one of Examples Ex7-Ex10, wherein one or both of the first and second communication protocols utilize a 3GPP-compliant payload.

Example Ex12: The device or method as in any one of Examples Ex1-Ex11, wherein the computing apparatus of the device is further configured to execute or the method further comprises:
receiving and demodulating a third signal on the second carrier frequency from the non-terrestrial device resulting in a second data signal;
modulating the second data signal on the first carrier frequency generating a fourth signal; and
transmitting the fourth signal to the terrestrial device.

Example Ex13: The device or method as in any one of Examples Ex1-Ex12, wherein the non-terrestrial device is one of an atmospheric satellite, low-earth orbit satellite, medium-earth orbit satellite, and high-earth orbit satellite.

Example Ex14: A system comprising:
a non-terrestrial device; and
a relay device to provide wireless communication between the non-terrestrial device and a terrestrial device, wherein the relay device is configured to:
   receive and demodulate a first signal on a first carrier frequency from the terrestrial device resulting in a data signal;
   modulate the data signal on a second carrier frequency generating a second signal; and
   transmit the second signal to the non-terrestrial device.

All patents, patent documents, and references cited herein are incorporated in their entirety as if each were incorporated separately. This disclosure has been provided with reference to illustrative embodiments and is not meant to be construed in a limiting sense. As described previously, one skilled in the art will recognize that other various illustrative applications may use the techniques as described herein to take advantage of the beneficial characteristics of the apparatus and methods described herein. Various modifications of the illustrative embodiments, as well as additional embodiments of the disclosure, will be apparent upon reference to this description.

What is claimed:

1. A relay device to provide communication between a non-terrestrial device and a terrestrial device comprising:
a wireless communication apparatus comprising one or more antennas to wirelessly communicate with a non-terrestrial device and a terrestrial device; and
a computing apparatus comprising one or more processors and configured to:
receive and demodulate a first signal on a first carrier frequency from the terrestrial device resulting in a data signal;
modulate the data signal on a second carrier frequency generating a second signal; and
transmit the second signal to the non-terrestrial device.

2. The relay device of claim 1, wherein receiving and demodulating the first signal on the first carrier frequency from the terrestrial device comprises beam forming a communication beam at the first carrier frequency to the terrestrial device.

3. The relay device of claim 1, wherein the first carrier frequency is different than the second carrier frequency.

4. The relay device of claim 1, wherein the first carrier frequency is the same as the second carrier frequency.

5. The relay device of claim 1, wherein one or both of the first and second carrier frequencies is one of LTE, 5G, and 6G as defined in 3GPP.

6. The relay device of claim 1, wherein the computing apparatus is further configured to, prior to the modulating the data signal:
decode the data signal according to a first communication protocol generating a data block; and
encode the data block according to a second communication protocol resulting in the data signal for modulation.

7. The relay device of claim 6, wherein the first communication protocol is different than the second communication protocol.

8. The relay device of claim 6, wherein the first communication protocol is the same as the second communication protocol.

9. The relay device of claim 6, wherein one or both of the first and second communication protocols is one of LTE, 5G, and 6G as defined in 3GPP.

10. The relay device of claim 6, wherein one or both of the first and second communication protocols utilize a 3GPP-compliant payload.

11. The relay device of claim 1, wherein computing apparatus is configured to:
receive and demodulate a third signal on the second carrier frequency from the non-terrestrial device resulting in a second data signal;
modulate the second data signal on the first carrier frequency generating a fourth signal; and
transmit the fourth signal to the terrestrial device.

12. The relay device of claim 1, wherein the non-terrestrial device is one of an atmospheric satellite, low-earth orbit satellite, medium-earth orbit satellite, and high-earth orbit satellite.

13. A method comprising:
wirelessly receiving and demodulate a first signal on a first carrier frequency from a terrestrial device resulting in a data signal;
modulating the data signal on a second carrier frequency generating a second signal; and
wirelessly transmitting the second signal to a non-terrestrial device.

14. The method of claim 13, wherein receiving and demodulating the first signal on the first carrier frequency from the terrestrial device comprises beam forming a communication beam at the first carrier frequency to the terrestrial device.

15. The method of claim 13, wherein the first carrier frequency is different than the second carrier frequency.

16. The method of claim 13, wherein the first carrier frequency is the same as the second carrier frequency.

17. The method of claim 13, wherein one or both of the first and second carrier frequencies is one of LTE, 5G, and 6G as defined in 3GPP.

18. The method of claim 13, wherein the method further comprises, prior to the modulating the data signal:
decoding the data signal according to a first communication protocol generating a data block; and
encoding the data block according to a second communication protocol resulting in the data signal for modulation.

19. The method of claim 18, wherein the first communication protocol is different than the second communication protocol.

20. The method of claim 18, wherein the first communication protocol is the same as the second communication protocol.

21. The method of claim 18, wherein one or both of the first and second communication protocols is one of LTE, 5G, and 6G as defined in 3GPP.

22. The method of claim 18, wherein one or both of the first and second communication protocols utilize a 3GPP-compliant payload.

23. The method of claim 13, the method further comprising:
receiving and demodulating a third signal on the second carrier frequency from the non-terrestrial device resulting in a second data signal;
modulating the second data signal on the first carrier frequency generating a fourth signal; and
transmitting the fourth signal to the terrestrial device.

24. The method of claim 13, wherein the non-terrestrial device is one of an atmospheric satellite, low-earth orbit satellite, medium-earth orbit satellite, and high-earth orbit satellite.

25. A system comprising:
a non-terrestrial device; and
a relay device to provide wireless communication between the non-terrestrial device and a terrestrial device, wherein the relay device is configured to:
receive and demodulate a first signal on a first carrier frequency from the terrestrial device resulting in a data signal;
modulate the data signal on a second carrier frequency generating a second signal; and
transmit the second signal to the non-terrestrial device.
